(19) United States
(12) Patent Application Publication
(10) Pub. No.: US 2013/0267251 A1
(43) Pub. Date: Oct. 10, 2013

(54) PERSONALIZED POSITION USING INFORMATION CORRELATION AND SELF-SOURCING

(71) Applicants: Behrooz KHORASHADI, Mountain View, CA (US); Ayman Fawzy NAGUIB, Cupertino, CA (US); Vinay SRIDHARA, Santa Clara, CA (US); Saumitra Mohan DAS, San Jose, CA (US)

(72) Inventors: Behrooz KHORASHADI, Mountain View, CA (US); Ayman Fawzy NAGUIB, Cupertino, CA (US); Vinay SRIDHARA, Santa Clara, CA (US); Saumitra Mohan DAS, San Jose, CA (US)

(73) Assignee: QUALCOMM INCORPORATED, San Diego, CA (US)

(21) Appl. No.: 13/546,450

(22) Filed: Jul. 11, 2012

Related U.S. Application Data
(60) Provisional application No. 61/622,476, filed on Apr. 10, 2012.

(51) Int. Cl. H04W 4/02; H04W 24/00

(52) U.S. Cl. 455/456.3; 455/456.1

(57) ABSTRACT

Some aspects relate to developing a personalized location feasibility heatmap, representing motion information related to a particular device/user, and combining that personalized heatmap with general location feasibility information, pertinent to a number of users. The personalized locational feasibility heatmap may be formed using self-sourced motion data, static and dynamic data, such as contacts and appointments, context, and data derived from or available through social networks. Heatmaps may be associated with respective areas; within areas, regions may be defined that are to be considered for self-source data, which have random data, or which are especially relevant to personalized heatmaps. Personalized heatmaps may be shared among users, and used as a basis for further modification. Other aspects, such as using personalized heatmaps relevant to one area to produce a personalized heatmap for a different area are disclosed. Mobile devices, and servers may implement disclosed aspects, separately or together.

### CROSS-REFERENCE TO RELATED APPLICATIONS

This application claims the benefit of and priority under 35 U.S.C. §119 to U.S. Provisional Patent Application No. 61/622,476, filed Apr. 10, 2012, and entitled “Personalized Position Using Information Correlation and Self-Sourcing,” which is assigned to the assignee hereof and which is incorporated herein by reference in its entirety. This application is related to U.S. patent application Ser. No. 13/180,464, filed Jul. 11, 2011, and entitled “Indoor Likelihood Heatmap”, which claims the benefit of and priority under 35 U.S.C. §119 to U.S. Provisional Patent Application No. 61/363,984, filed Jul. 13, 2010, and entitled “Movement Heatmap,” both of which are assigned to the assignee hereof and both of which are incorporated herein by reference. This application is also related to U.S. patent application Ser. No. 13/180,153, filed Jul. 11, 2011, and entitled “Methods and Apparatuses for Use in Generating an Encoded Routeability Graph Description,” which claims the benefit of and priority under 35 U.S.C. §119 to U.S. Provisional Patent Application No. 61/363,980, filed Jul. 13, 2010, and entitled, “Map Reduction,” both of which are assigned to the assignee hereof and both of which are incorporated herein by reference.

### BACKGROUND

I. Field

This disclosure relates generally to apparatus and methods for position determination, and more particularly to forming probabilistic position maps and using such maps in position estimation.

II. Related Art

A computer that forms estimates of positions based on a set of inputs may be known as a Position Engine (PE). A PE receives a probability map, which may be based on historical position data for a user. A PE may attempt to estimate a current position of the user based on the historical position data. Such a probability map can be called a heatmap, in that the probability map may refer to spatial locations (e.g., in a 2-D or 3-D region), and include probability data concerning characteristic(s) of interest in that region.

PEs may use probabilistic location information generated from crowd sourcing. For example, such crowd sourced data may show that an undifferentiated user is most likely found in common areas such as a meeting place, restroom or a hallway and less likely to be found in a private office. Locational awareness and position estimation are topics of continued interest.

### SUMMARY

Some embodiments disclose a method for position estimation, the method comprising: accessing from a non-transitory medium, a general heatmap representing a generic position feasibility pattern for mobile devices within an area to which the general heatmap pertains; accessing a personalized heatmap from the non-transitory medium, a personalized heatmap representing a position feasibility pattern for a user, within the area to which the general heatmap pertains; combining data from the general heatmap and the personalized heatmap to form a combined heatmap; and estimating a current position of the user using the combined heatmap.

Some embodiments disclose a mobile device for position estimation, the mobile device comprising: a receiver operable for receiving data representative of a general heatmap, the general heatmap representing a generic position feasibility pattern for mobile devices within an area to which the general heatmap pertains; and a processor configured to generate a personalized heatmap specific to the mobile device independently from the general heatmap, to combine the general heatmap and a personalized heatmap to produce a combined heatmap, and to determine an estimate of a position of the mobile device from the combined heatmap.

Some embodiments disclose a mobile device for position estimation, the mobile device comprising: means for receiving a general heatmap, the general heatmap representing a generic position feasibility pattern for mobile devices within an area to which the general heatmap pertains; means for generating a personalized heatmap specific to the mobile device, a personalized heatmap generated independently from the general heatmap; means for combining the personalized heatmap and the general heatmap to produce a combined heatmap; and means for determining an estimate of a position of the mobile device from the combined heatmap.

Some embodiments disclose a device comprising a processor and a non-transitory memory wherein the non-transitory memory includes instructions to: determine a general heatmap for an area in which augmented location services are to be provided, the general heatmap representing a generic position feasibility pattern for mobile devices within the area; generate a personalized heatmap of an area specific to a mobile device, the personalized heatmap generated independently from the general heatmap; and provide the personalized heatmap for use in determining an estimate of a position of the mobile device using data from both the general heatmap and on the personalized heatmap.

Some embodiments disclose a non-transitory computer-readable storage medium including program code stored thereon, comprising program code to: receive a general heatmap, the general heatmap representing a generic position feasibility pattern for mobile devices within an area to which the general heatmap pertains; generate a personalized heatmap, wherein the personalized heatmap is specific to a mobile device, and the personalized heatmap generated independently from the general heatmap; and determine an estimate of a position of the mobile device using data from both the general heatmap and the personalized heatmap.

Some aspects relate to determining a set of regions of the heatmap and a set of general regions of the heatmap, which may be used to determine data collection practices in such regions. The personalized heatmap also may be generated to include or be based on information obtained from one or more position history of the mobile device, a calendar and a contact list on the mobile device. Information used in such generating may come from a network-accessible repository of information, such as social networking services used by the user of the mobile device or a server run by an organization to which the user is associated. Social networks may be explicit or inferred based on other available information.

The personalized heatmap may be regenerated responsive to availability of new or additional information. Further aspects include computer readable media storing instructions for implementing the disclosed process aspects. Process aspects may be performed at a server.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

The following detailed description makes reference to the following figures.

FIG. 1 depicts an example indoor area, which may be represented by a floorplan over which a likelihood heatmap is projected, in which a mobile device may travel according to an implementation.

FIG. 2 depicts an example sparse connectivity graph overlay for an indoor area according to an implementation.

FIG. 3 depicts an example heatmap for an indoor area.

FIG. 4 shows a flow chart combining a general heatmap with a personalized heatmap to form a combined heatmap that is feed to a position engine (PE).

FIG. 5 depicts forming a personalized heatmap from various types of personal information.

FIG. 6 depicts an example of static data that may be used in personalized heatmap generation.

FIG. 7 depicts an example of designating regions or locations within an area, which may control how data is gathered and/or processed in order to produce personalized heatmaps for users in the area.

FIG. 8 depicts an example of a personalized heatmap overlayed on a floorplan of an area to which a general heatmap pertains.

FIG. 9 depicts another example of a personalized heatmap overlayed on a schematic of an area to which a general heatmap pertains.

FIGS. 10 and 11 depict examples of personalized heatmaps discussed with respect to FIGS. 8 and 9, and show high and medium feasibility areas for user(s) to which the heatmaps pertain.

FIG. 12 depicts an example process of data collection for an area, in which regions thereof may be allocated between self-sourced and group data collection.

FIG. 13 depicts an example of deriving an implicit social network involving a user, and which may serve as a basis for data gathering in furtherance of heatmap generation.

FIG. 14 depicts an example process of gathering data from a variety of sources that may be used in generating a personalized heatmap for an area.

FIG. 15 depicts an example process of identifying a user having a personalized heatmap for an area that may be useful as a basis for a personalized heatmap of another user, or from which data may be sourced.

FIG. 16 depicts an example process of combining a general heatmap and a personalized heatmap to generate a combined heatmap.

FIG. 17 depicts a diagram of an example server and other elements that may interoperate, or otherwise relate to personalized heatmap generation, in determining combined heatmap data.

FIG. 18 depicts an example functional composition of a mobile device and including storage of likelihood heatmap instructions for implementing one or more aspects relating to indoor likelihood heatmaps according to an implementation.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

This disclosure begins by introducing substituent technologies, such as satellite positioning system and wireless networking technologies, then proceeds to introduce details concerning location and locational heatmaps, and in particular the formation of personalized heatmaps independently but for use with general heatmaps for determining locational probability of particular mobile devices. Thereafter, a variety of examples of sources of information and other approaches to forming and revising personalized heatmaps are disclosed. Following that disclosure, a variety of processes that summarize the usage of such information in forming/revising personalized heatmaps, and other related processes are disclosed, and ultimately, examples of a mobile device and a server that may be used to practice aspects disclosed herein are depicted and described.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems.

By way of example, an SBAS may include an augmentation system that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

Navigational or other location-based services may rely at least partially on determining at least an estimated position of a mobile device. However, positioning strategies that are effective in outdoor environments, which may utilize satellite positioning system (SPS) signals or satellite imagery, may be inadequate for indoor environments. Thus, as is explained further herein below, performing a positioning operation indoors to estimate a location of a mobile device may involve different techniques or strategies as compared to those that may be used outdoors. Within indoor environments, mobile devices may attempt to effectuate indoor positioning at least partly by processing signals transmitted from transmitters (e.g., wireless transmitter devices) that are located, for example, within an indoor environment at known locations. Examples of transmitters may include wireless transmitter devices that comport with a Wi-Fi access point protocol (e.g., IEEE 802.11), a Bluetooth protocol, a femtocell protocol, or any combination thereof.

As a user travels within an indoor area while carrying a mobile device, position estimates of the mobile device may be at least partially determined using, for example, one or more signals transmitted from at least one transmitter. A mobile device may measure characteristics of signals received from one or more transmitters. Such characteristics may include received signal strength indicator or indication (RSSI) measurements, round trip time (RTT) measurements, round trip delay (RTD) measurements, time of arrival (TOA) measurements, angle of arrival (AOA) measurements, or combinations thereof. Using measurements of received wireless signals along with techniques that are known in the art (e.g., trilateration), a location of a mobile device may be estimated. With trilateration, for example, a mobile device may use well known techniques to obtain a position fix from ranges to multiple transmitters that are positioned at known locations. Ranges to transmitters may be measured based, at least in part, on received wireless signal characteristics (e.g., RSSI, RTT, RTD, TOA, AOA, etc.).

Wireless signal reception measurements with one or more transmitters may enable estimation of a location of a mobile device or may aid in refining an estimated location. Unfortunately, wireless signal reception measurements may be costly in terms of energy usage, latency, or computational complexity, for example. Furthermore, no transmitters or an insufficient number of transmitters may be in communication range with a mobile device at any given moment. Hence, other mechanisms for determining an estimated location, which may not entail measuring a characteristic of a received signal, may additionally or alternatively be employed.

Indirect mechanisms that may be used to determine an estimated location may comprise indirect measurements, predictive procedures, mobility models, or any combinations thereof. For example, a movement model may indicate a possible or likely movement pattern of a mobile device. Implementation of a movement model may include application of positional filtering, consideration of a likely speed of perambulation (e.g., a reasonable or maximum walking speed), or applying a smoothing procedure to a traveled path, etc., just to name a few examples. Other indirect mechanisms may indicate, for example, relative positional movement of a mobile device. Relative positional movement may be determined using one or more indirect measurements. Indirect measurements may be obtained from, by way of example only, one or more inertial sensors such as accelerometer(s), pedometer(s), compass(es), gyroscope(s), or any combination thereof. Additionally or alternatively, determination of a relative positional movement may use, by way of example only, at least one mobility model that considers average or maximum velocity of a pedestrian, a previous location, a previous velocity (e.g., a previous speed or a previous direction of travel, etc.), one or more probabilistic mechanisms, a path smoothing procedure, a path filtering procedure, or any combination thereof.

Determination of location estimates of a mobile device or a trajectory or a path of a mobile device within an indoor area may be enabled or enhanced using one or more probabilistic mechanisms. By way of example, a position of a mobile device may be represented as a probability distribution. A probability distribution may comprise, by way of example: (1) a range of possible values that a random variable may take; (2) a probability that a value of a random variable falls within a measurable subset of a range of possible values; or (3) any combination thereof. To model a mobile device's movement within a physical indoor area, a probability distribution may be propagated around a schematic map modeling or representing the physical indoor area. To implement a probabilistic mechanism, a Bayesian or smoothing filter may be applied to location estimates or a process of determining location estimates. Implementation of a probabilistic mechanism may include consideration of a current location or trajectory of a mobile device. Additionally or alternatively, a Kalman filter or a particle filter may be applied to location estimates or a process of determining location estimates. Other probabilistic mechanisms may additionally or alternatively be implemented without departing from claimed subject matter.

With a particle filtering implementation, by way of example only, a mobile device's location(s) or estimated locations may be represented by multiple particles. Each particle may represent a possible state or location of a mobile device. A combination of multiple particles (e.g., an average, a centroid, a mean, etc. with an error or confidence range that is derived from a combination of multiple particles) of a particle cloud may be considered at least one estimated location of a mobile device. Additionally or alternatively, one or more individual particles of multiple particles of a particle cloud may be considered at least one estimated location of a mobile device. In response to movement of a mobile device, particles may be propagated according to a probability distribution. Particles may be propagated in accordance with a probability distribution further along a corridor, around a corner, by branching at an intersection, by taking a portal (e.g., a stairway, an escalator, an elevator, etc.) to a different floor, or any combination thereof.

Particle filtering may therefore be used as an indirect mechanism to determine or refine an estimated location of a mobile device. With particle filtering, potential locations of a mobile device may be represented by particles in a particle cloud that are propagated using a probabilistic model. If a position fix is made for a mobile device at a given position, multiple particles may be propagated away from the given position in accordance with one or more parameters. A user may continue along a current trajectory, veer off leftward or rightward, make a left or a right turn, cease movement, reverse direction, or make some other movement. A particle may be assigned to represent each of these possible user movements. For instance, if a user is approaching an intersection where one of two possible hallways may be taken, particles of a particle cloud may split into two particle clusters at two different positions, with a first particle cluster propagating down a first hallway and a second particle cluster propagating down a second hallway. Some example implementations are described herein in terms of particle filtering.

A user carrying a mobile device may travel within an indoor environment. To provide to a user of a mobile device a location-based service via a navigational application, an estimated position of a mobile device within an indoor environment may be determined by a positioning engine of the mobile device. An indoor environment may be envisioned as having a grid of points projected or laid over it. A grid of points may have any number of points that are sufficient to cover an indoor area or provide a desired level of granularity or precision. Adjacent points of a grid of points may be spaced apart at six inch increments, one foot increments, one-and-a-half foot increments, or three foot increments, etc., just to name a few examples.

A current estimated location of a mobile device may be estimated, for example, via a position fix attained using one or more range determinations with one or more transmitters as is described above. A current estimated location of a mobile device may correspond to a determined point of a grid of points. From a determined point, a number of particles may be established and permitted to move around an indoor area based on one or more conditions or properties for a current epoch that extends for a given duration of time. By way of example only, hundreds of particles may be propagated for two to four seconds per epoch. Absent other indications, a likelihood that one or more particles are to move to any given point of a set of adjacent or equally-proximate points may be equal. However, given a layout of an indoor area, it may become apparent that a mobile device is actually more likely to be located at or moving to some points as compared to other points.

Indoor areas, such as office buildings or malls, may include hallways and rooms, for example. In an office environment, rooms may include common rooms (e.g., a break room, a conference room, etc.) or individuals' rooms (e.g., a personal office, a cubicle, etc.). In such an office environment, a likelihood that a person is to move to a given point during a current epoch may depend, at least in part, on whether a given point is located within a hallway, a common room, or an individual's room. For example, users may generally be more likely to be traveling in a hallway than in a common room or more likely to be traveling in a common room than in an individual's room. Consequently, there may be a greater likelihood that a mobile device starting at a particular point of a grid of points is moving to a first point that is within a hallway than is moving to a second point that is within an individual's room.

Particles that are being propagated from one point to other points may be more accurately propagated if likelihoods of where mobile devices are likely to be traveling or likely to be positioned are taken into consideration by, for example, a particle filtering process of a positioning engine of a mobile device. A likelihood heatmap for an indoor area may indicate respective likelihood values for respective points of a grid of points that is laid over an indoor area. Likelihood values of a likelihood heatmap may indicate relative likelihoods that a mobile device is to be positioned at one point as compared to other points or is to move to a next point from a current point. As an example, particles may be propagated during a current epoch according to a likelihood heatmap to determine where individual particles are likely to be when the current epoch expires. More generally, position outputs may be biased through a filtering process to indicate that certain regions are probabilistically more likely in generating position outputs.

As described further herein below, an indoor likelihood heatmap may be pre-computed based, at least in part, on one or more features of an indoor area, such as walls, doors, hallways, rooms, or any combination thereof. For certain example implementations, relative likelihoods for different points of a grid of points may be generated based, at least in part, on feasible paths between grid point pairs of the grid of points. Feasible paths between grid point pairs may comprise those paths extending between a first point and a second point that do not pass through an obstruction, such as a wall, of an indoor area.

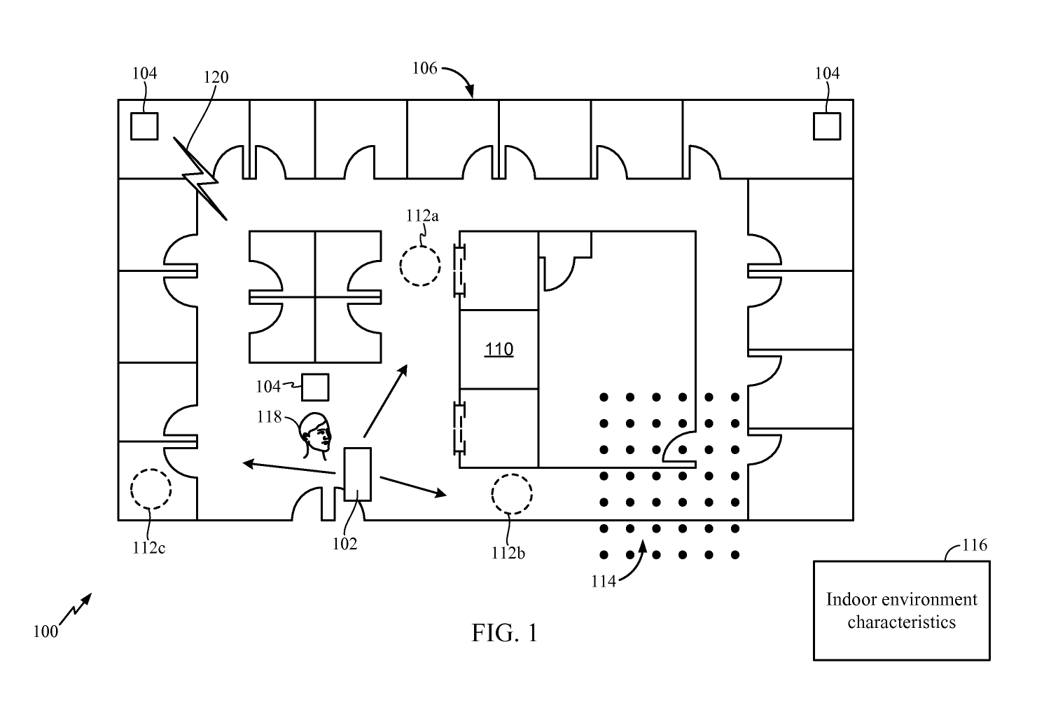

In an example implementation as depicted in FIG. 1, indoor area 100 may be represented by a schematic map 106. Schematic map 106 may comprise, by way of example only, indications of one or more features that are descriptive of at least one indoor area. Features of a schematic map may represent attributes of a physical layout or a physical organization of at least one indoor area. For example, features of a map may indicate locations, lengths, or sizes, etc. of walls, rooms, doors, entryways, hallways, passageways, corridors, dividers, railings, portals between floors, obstructions, or any combination thereof, just to name a few examples. Schematic map 106 may further include one or more indications of one or more infeasible areas 110. An infeasible area 110 may comprise an area to which a person does not appear to normally have access, such as an enclosed area without a door. For instance, there may be no door for infeasible area 110 because it represents space for elevator machinery. As another instance, a space on a second floor that is open to a first floor below may be indicated to be infeasible on the second floor (e.g., even if a corresponding space on the first floor is indicated to be feasible). In contrast, a feasible area may comprise a space to which a person does appear to have access, such as a room having a doorway.

As indicated above, indoor environment characteristics 116 may include transmitter characteristics. Transmitter characteristics may include a position of one or more transmitters 104. To provide positions of one or more transmitters 104 for indoor environment characteristics 116, schematic map 106 may also include representations of transmitters 104 or indications of positions thereof. Additionally or alternatively, one or more transmitters 104 may be linked to one or more locations on schematic map 106. Schematic map 106 for an indoor area 100 may be used to facilitate navigation or mobile device positioning within an indoor environment.

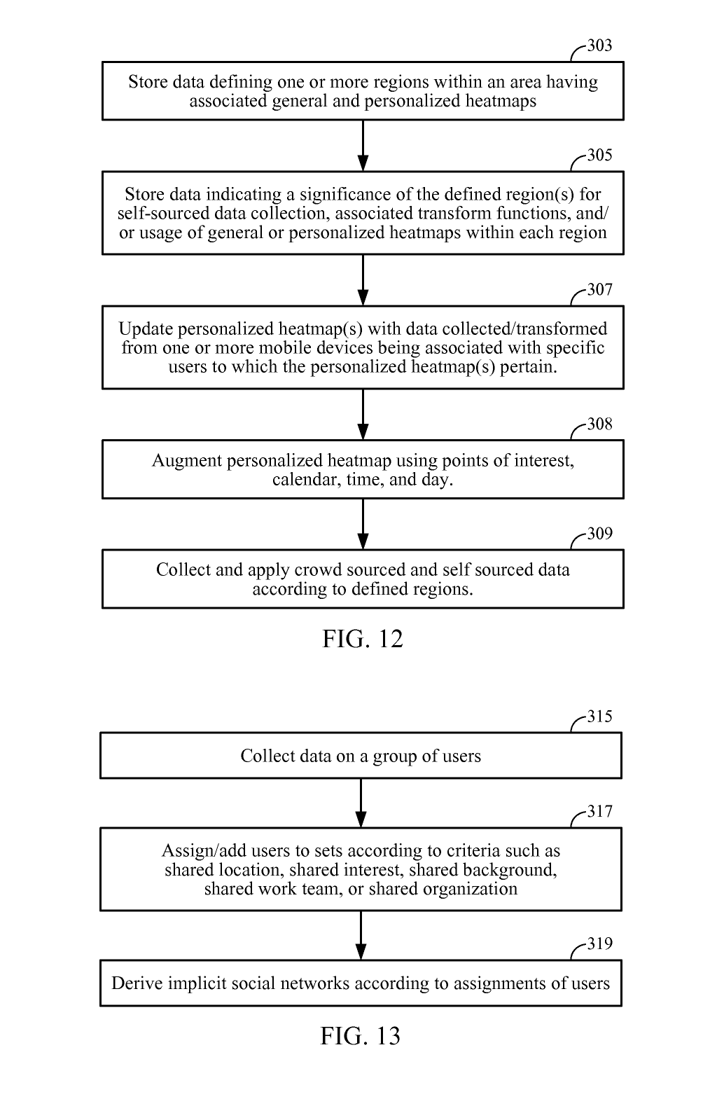

For certain example implementations, a user 118 may travel in indoor area 100 while carrying a mobile device 102. Mobile device 102 is illustrated at an entryway of indoor area 100. User 118 may proceed in any of many possible directions as represented by three arrows that indicate three example directions. Mobile device 102 may communicate via one or more wireless signals 120 with a transmitter 104 from time to time. A wireless signal 120 may be, for example, transmitted from mobile device 102 and received at transmitter 104 or transmitted from transmitter 104 and received at mobile device 102. Although only one mobile device 102 or three transmitters 104 are explicitly shown in FIG. 1, more or fewer of either or both may alternatively be involved in a given implementation without departing from claimed subject matter. Furthermore, example implementations may include a server (not shown in FIG. 1). Example realizations for a server, as well as additional server examples, are described herein below with particular reference to at least FIG. 12.

Examples of mobile device 102 may include a mobile phone, a mobile station, user equipment, a smart phone, a cellular phone, a netbook, a laptop computer, a notebook computer, a tablet computer, a slate computer, a personal digital assistant (PDA), a personal navigation device (PND), an entertainment appliance, an e-book reader, or some combination thereof, just to name a few examples. Furthermore, mobile device 102 may comprise any mobile device with wireless communication capabilities. Example realizations for a mobile device, as well as additional mobile device examples, are described herein below with particular reference to at least FIG. 13.

In example implementations, transmitter 104 may comprise a Wi-Fi or wireless local area network (WLAN) access point (AP), a femtocell device, a WiMAX device, an indoor location beacon, a Bluetooth or other similarly short-ranged wireless node, or any combination thereof, just to name a few examples. Transmitter 104 may transmit wireless signals 120 including those that are capable of identifying a particular wireless access device or those that may be useful for estimating a position of a mobile device. Mobile device 102 may be within wireless communication range of one or more transmitters 104 or in wireless communication with one or more transmitters 104. Transmitter 104 may also be capable of receiving the wireless signals 120 or may comprise a wireless access device generally that is capable of both transmitting and receiving the wireless signals 120. Transmitter 104 may be located such that it corresponds to or is capable of communicating with mobile devices that are within a particular indoor area 100, such as a particular floor of a building.

During wireless communications, wireless signals 120 that are received at mobile device 102 from a particular transmitter 104 may be modulated with a unique device identifier that identifies the particular transmitter 104. For a Wi-Fi AP implementation of transmitter 104, a unique device identifier may comprise an AP medium access control identifier (MAC ID). Transmitter 104 may further interact with mobile device 102 so as to enable signal reception measurements to be performed by mobile device 102. Signal reception measurements may include RSSI measurements, RTT measurements, RTD measurements, TOA measurements, AOA measurements, or any combination thereof.

As mobile device 102 travels within indoor area 100, position estimates of mobile device 102 may be determined using, for example, wireless signals 120 received from one or more transmitters 104 that are positioned at known locations of indoor area 100. For example, a range between a mobile device and a transmitter may be estimated using one or more signal characteristics, such as RSSI, RTT, RTD, TOA, AOA, or any combinations thereof. Measuring a range to a transmitter having a known location may enable a mobile device to estimate its location within an indoor area along a circle, or portion thereof (e.g., an arc), having a center where the transmitter is located. By acquiring a unique device identifier that is modulated in a signal from a transmitter having a known location, a mobile device may at least measure a range to the transmitter. Measurement of a range to a transmitter having a known location with respect to an indoor area may be used to refine an estimated location (e.g., a likely position). Additionally or alternatively, a mobile device may measure one or more ranges to one or more transmitters to estimate its location. Using measurements from at least three transmitters along with techniques that are known in the art (e.g., trilateration), a position of a mobile device may be estimated by combining three or more range measurements. In other words, with trilateration for example, a mobile device may utilize well known techniques to obtain a position fix using ranges to transmitters at known locations with ranges determined at least partly from received wireless signal characteristics (e.g., RSSI, RTT, RTD, TOA, AOA, etc.).

Additionally or alternatively, a mobile device may obtain a position fix based, at least in part, on a comparison of received wireless signal characteristics (e.g., RSSI, RTT, RTD, TOA, AOA, etc.) to one or more values of a heatmap. A signal characteristic heatmap may indicate one or more received wireless signal characteristic values that correspond to a given position within an indoor environment. If a mobile device acquires at least one signal having characteristics that match wireless signal characteristic values that correspond to a given position as indicated by a heatmap, then the mobile device may infer that it is located at the given position. If estimated locations are being determined from wireless signal characteristic values, for example, such estimated locations may be adjusted or refined using a likelihood heatmap 114.

A heatmap, such as likelihood heatmap 114, may be laid over or projected onto schematic map 106. A heatmap may comprise or indicate one or more values that correspond to one or more positions of an indoor area. In example implementations, heatmap values may comprise location likelihood values that indicate relative likelihoods (e.g., relative probabilities) that a mobile device may be located at one position of an indoor area as compared to other positions of the indoor area. A likelihood value may comprise a single number, a numerical range, a probabilistic range (e.g., a mean plus/minus a standard deviation), or any combination thereof.

A heatmap may include a map of indoor area 100 to which it corresponds. Additionally or alternatively, a heatmap may reference positions that are defined or otherwise specified in a map that is included as part of, e.g., schematic map 106. For the sake of visual clarity in FIG. 1, only a portion of likelihood heatmap 114 is shown; a heatmap may actually cover less or more (e.g., an entirety) of indoor area 100. Also, as shown in FIG. 1 merely for purposes of illustration, a heatmap, such as a likelihood heatmap 114, may comprise multiple discrete points that are organized in a grid or other arrangement. Additionally or alternatively, a heatmap, such as a likelihood heatmap 114, may comprise likelihood values that indicate or are determined based, at least partly, on a continuous positional basis or may comprise contours defined by likelihood values or likelihood value ranges.

In an example scenario, if a user 118 enters indoor area 100 with mobile device 102, user 118 may travel in any of a number of potential directions. Three example directions are shown by three arrows pointing away from mobile device 102. These three example directions may lead respectively to three potential positions 112a, 112b, or 112c. Although it may appear at first that mobile device 102 is equally likely to be located at or moving towards each potential position 112a, 112b, or 112c (or any given position of indoor area 100), this may not be the case due at least partially to an organizational layout or due to building features of indoor area 100. For example, as explained herein above, user 118 may be more likely to be positioned in a hallway than in a particular room, or user 118 may be more likely to be positioned in a common room than in another individual's room.

With reference to FIG. 1 specifically, potential position 112a may be located outside an elevator bank that may lead to multiple other floors of a multi-floor building in which indoor area 100 may correspond to a first floor, for example. Potential position 112b may be located along a hallway that leads to multiple other individual offices. Potential position 112c may be located within a single individual office. Consequently, user 118 (e.g., a general user that is not an occupant of the single individual office) may be less likely to be heading towards or located at potential position 112c as compared to potential position 112b or potential position 112a. Similarly, if it were given that the entrance to a building is on a first floor as represented by indoor area 100 and that each of multiple other floors have multiple individual offices, user 118 (e.g., a general user that is not the occupant of an individual office of the first floor of indoor area 100) may be less likely to be heading towards or located at potential position 112b as compared to potential position 112a, which is adjacent to an elevator that provides access to other floors.

A likelihood heatmap 114 may provide indications of relative likelihoods that a mobile device is located at one position as compared to other positions of indoor area 100. For certain example implementations as described herein, determination of a likelihood heatmap 114 for indoor area 100 may be based, at least in part, on schematic map 106. Natural traffic patterns due to an organizational layout of indoor area 100 may be taken into consideration. Additionally or alternatively, natural walking paths due to building features of indoor area 100 may be taken into consideration. For instance, there may be more user traffic through centers of hallways than along edges of hallways. Similarly, there may be more user traffic through centers of rooms than in corners of rooms. Example implementations for generating or using likelihood heatmaps are described further herein below.

Timing and calendar information also can be used in determining individualized heatmaps. For example, time and day characteristics can include time of day, day of week, work day, day off from work; some of these characteristics may be universal among all users (e.g., time of day, for a particular geographic location), while others can vary among users—such as work day/day off.

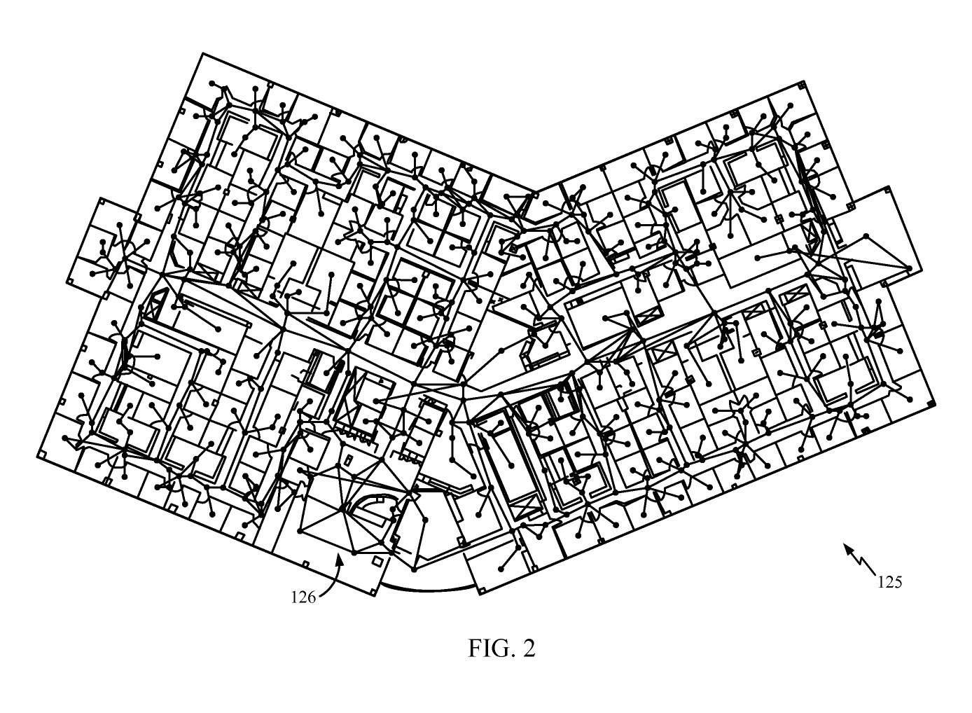

FIG. 2 is a schematic map 125 of a floor of a building that illustrates an example sparse connectivity graph according to an implementation. A sparse connectivity graph 126 may correspond to a dense connectivity graph. As shown, reduced points of sparse connectivity graph 126 may be determined such that they are generally positioned in hallway intersection points or centers of rooms or other locations that might be expected to have relatively higher traffic patterns. Each point of a dense connectivity graph may have a line-of-sight to at least one point of sparse connectivity graph 126.

To produce a likelihood heatmap, shortest paths between pairs of points in a dense connectivity graph may be determined. The shortest paths may be constrained to travel through points of a sparse connectivity graph. This constraint may produce shortest paths that travel through points that are expected to be located along well trafficked routes. As paths are determined, a counter indicating a number of times a particular point or an edge has been traversed may be increased (e.g., incremented). Points or edges that lie along relatively more common paths may therefore be incremented more often than those points or edges that lie along relatively less common paths. As a consequence, points in a central region of a hallway or points in a central region of a room may be assigned relatively higher likelihoods for a likelihood heatmap. Furthermore, points of a dense connectivity graph that are shared with a sparse connectivity graph may be assigned relatively higher likelihoods as compared to points of a dense connectivity graph that are not shared with a sparse connectivity graph. Paths between points of a sparse connectivity graph may similarly be more likely than paths that do not link points of a sparse connectivity graph. Paths into or out of a room may be routed through a center of the room. Thus, a likelihood of being present at or moving to centers of rooms may be relatively greater as well. This routing may create natural likelihood “black holes” in centers of rooms.

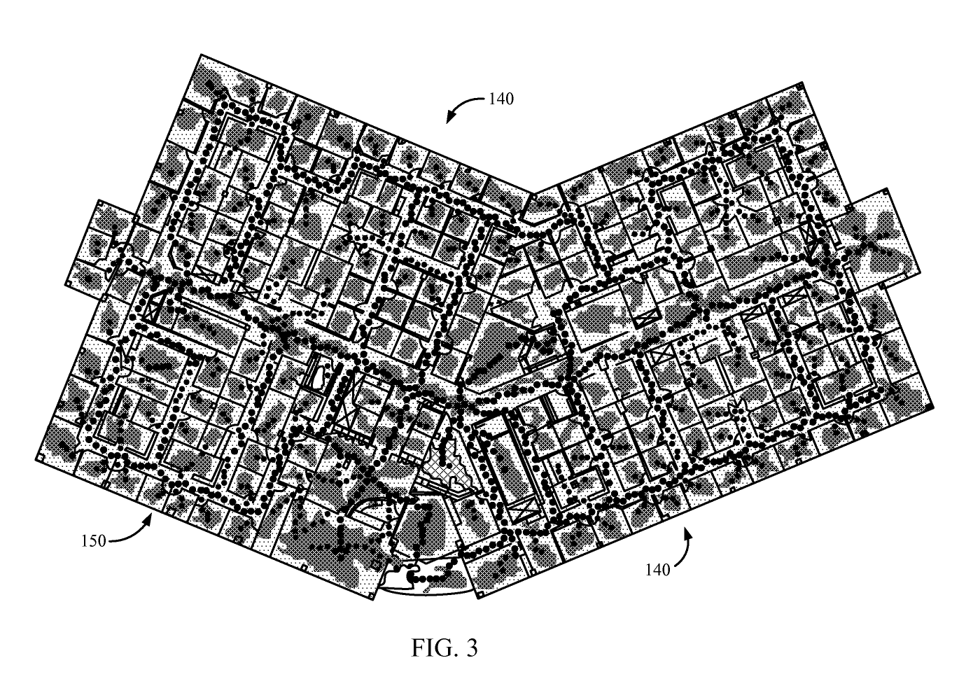

FIG. 3 depicts schematic map 125 (FIG. 2) with an example heatmap 140, which depicts a likelihood heatmap may include multiple points that correspond to positions of an indoor area. Such heatmap 140 may be generated by applying e.g. a Dijkstra shortest path procedure on multiple grid point pairs of a dense connectivity graph, as constrained by sparse connectivity graph 126 overlay. In example implementations, positions of a likelihood heatmap may have associated likelihood values. Multiple points or locations of a likelihood heatmap may correspond to multiple points of a dense connectivity graph. Additionally or alternatively, a dense connectivity graph or a dense likelihood heatmap may be pruned to produce a likelihood map that is reduced compared to an original dense connectivity graph but still sufficiently dense to meet parameters that are specified by a positioning system.

As shown in heatmap 140, a likelihood value or relative range for multiple positions may be indicated using shadings. Darker (e.g., black) points may have higher likelihood values, and increasingly lighter (e.g., gray to white) points may have increasingly lower likelihood values. In heatmap 140, the darkest points are generally located along central regions of hallways. Dark gray points generally lead from hallways into central regions of rooms. Light gray points generally spread out around central regions of rooms. White points are generally located between central regions of rooms and perimeters of rooms. These figures depict examples of positional and locational feasibility patterns and probability data, which can be combined, weighted and otherwise manipulated according to the disclosure.

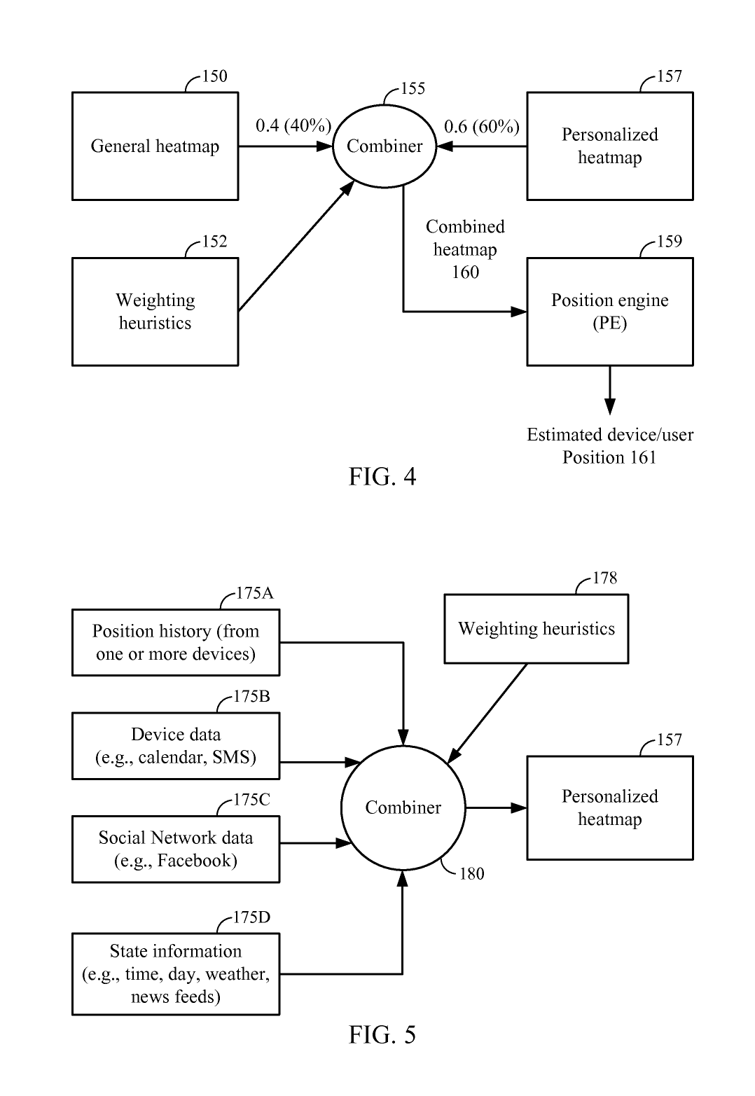

FIG. 4 depicts combining using combiner 155 a general heatmap 150 with a personalized heatmap 157 to form a combined heatmap 160 that is feed to a position engine (PE 159). The general heatmap 150 probabilistically describes where a general mobile device (and the user of a mobile device) will most likely be. For example, most users are likely found in a main hallway and other common areas. For a particular office, most users are very unlikely to be found in that office. PE 159 is an example of a means for predicting locational feasibility, as it outputs a position estimate using combined heatmap 160.

However, for a particular user, individual habits may be known. For example, a particular user is most likely in his or her office. The next most likely space that that particular user is likely to be found is a frequented space (such as a bathroom closest to their office, a particular conference room or colleague's office, entry/exit door, eating/snake area) or in an hallway or hallways that join these spaces. Personalized heatmap 157 may be created that is based on historical positions of an associated user.

In an example, a combiner 155 may produce a weighted combination of general heatmap 150 and a weighted version of personalized heatmap 157 and use those weighted versions, in order to generate combined heatmap 160 that takes into account both the habits of users generally and the personal habits of the particular user to which personalized heatmap 157 pertains. Weighting heuristics 152 may be used to determine an appropriate weighting of data from general heatmap 150 and personalized heatmap 157 in forming combined heatmap 160. Using combined heatmap 160 as an input parameter, PE 159 may better estimate a device's position (estimated device/user position 161) than it could have with either the general heatmap or the personalized heatmap alone. PE 159 is a means for determining a position.

FIG. 5 depicts an example of using a set of information in generating personalized heatmap 157. In the depiction, position history 175A (from one or more devices), device data 175B (e.g., calendar, SMS), and social network data 175C (e.g., Facebook), and state information 175D (e.g., time, day, weather, news feeds) individually, any subset thereof, or collectively may be inputted to a combiner 180 in order to produce personalized heatmap 157. Combiner 180 and combiner 155 are means for combining. Combiner 180 is a means for generating locational feasibility information, in that combiner 180 receives various information, and outputs a personalized heatmap that includes locational feasibility information, which is information available. By way of introductory example, device data 175B may comprise contacts on the device, and information correlating contacts to meetings, and meeting locations. Such information may be used to augment or form personalized heatmaps for such users. Such information may be relevant for the user of the device from which such data is accessed, but such information also may be relevant for users referenced or appearing in such data, or who, through other available data sources, may be found to have a connection to the user, which suggests relevancy of such data.

As an example, scores from the personalized and general heatmap can be respectively outputted and some relative weighting applied to each score to get a total score. For example, a heatmap can be formed from a 60% weighting of personal and 40% general. The general heatmap score can be a starting basis, and the personalized heatmap score can be added to it. For example, if a lunch room is highly likely and a user tends to spend time there, the probability of that room should become higher, being a combination of both that individual user's personal heatmap and the general heatmap probabilities. Similarly, a set of bathrooms may have a certain probability in a general heatmap, but a personal heatmap may show that a particular user frequents one, so that one can be weighted more heavily.

In a calendar situation, a weighting factor from the personalized heatmap could be made higher still, for example to 0.8, under circumstances where it is a strong indicator. That strong weighting should be temporally applied around each particular invite time. For example, a guard band, such as 10 minutes before and after the invite time, can be provided.

These example show that the combining of personalized and general heatmap data can be dynamic and based on many different factors, such as calendar information, and contextual inputs.

Position history 175A is formed from previous days, months or years and is not an immediately preceding position estimate, such as from a recent satellite positioning fix. Various examples and approaches to using data in accordance with and in the spirit of such example are described below. For example, personalized heatmap 157 may be formed with just historic position information. However, more elaborate approaches to produced personalized heatmap 157 may be employed in implementations according to the disclosure.

For example, categories of data capable of being used in forming personalized heatmap 157 include categories of static data, dynamic information, self-sourced information, explicit social network information, implicit social network information, device data, and context, by example. Weighting heuristics 178 may encode or otherwise provide data determining how to combine the depicted data sources in different situations, as would be evident from the disclosure.

In an example, static data may be used to help pre-personalize feasibility patterns, e.g., locational feasibility, which may be further modified by dynamic data. As used herein, the terms static and dynamic are relative in the sense that static data is relatively long lived and updated less frequently, while dynamic data is nearer to real-time data, and for example, may be updated or made available within a timeframe while a user is moving, or in anticipation of user movement. By contrast, static data is updated less frequently, where some types of static data may be relatively permanent, such as an office location (as example delineated in more detail below) while other static information may change daily or weekly, such as calendar information. When static data is updated, the update to such static data may itself be treated as dynamic data when the update is promulgated.

Here, high, medium and low feasibility are textual descriptors for degrees of feasibility, and are by way of example, not limitation. Numerical ranges can be assigned for each of high, medium and low feasibility. These ranges can be assigned for particular regions, and for particular users. These ranges can be dynamic, as more information becomes available about regions and users.

Examples of state information 175D and usage thereof include that information such as a current day of the week, time of day, weather, traffic conditions, syndicated information feeds, and so on. State information 175D can individually and collectively be used in determining aspects of the personalized heatmap 157. For example, personalized heatmap 157 may be have different content for a weekend versus a weekday, and may be continually updated throughout the day. For example, a lunchtime heatmap may differ from a non-lunch time heatmap. As an example, lunch times for one users may be found to vary from day to day, and different users may have predictably different lunch times. These characteristics can be gathered through self-sourcing of data such as the disclosed position data, social network data 175C, and device data 175B. As another example, a degree of predictability of user behavior can be used to weight such information in generating the personalized heatmap 157. For example, some users may have highly regular patterns of behavior dictated by personal preferences, group meetings, friends, or other associations or commitments. Such behavior may have repeating characteristics over one or more different periods of time, such as day-to-day, week-to-week, the first-of-the-month, and so on.

Weightings of such information can account for factors according to these examples, and can have joint dependencies. For example, a particular user may have a highly predictable lunch destination when having lunch with a particular person or group, but may have specific preferences that are followed when eating alone. Such patterns and dependencies can be used in determining an appropriate weighting for the different elements of information available in producing a personalized heatmap 157 for a particular user, and which also may be associated with a particular timeframe, such as a workday morning, a last Friday of the month, end of quarter, travel plans of known team members, and so on. Weightings can be relevant internally among personalized heatmap data, and relatively weight personalized and general heatmaps.

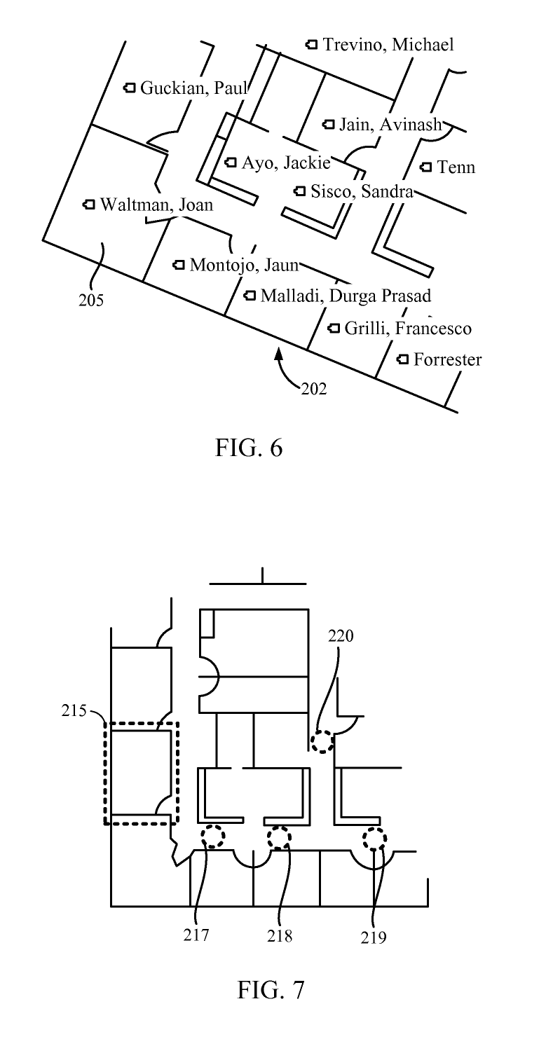

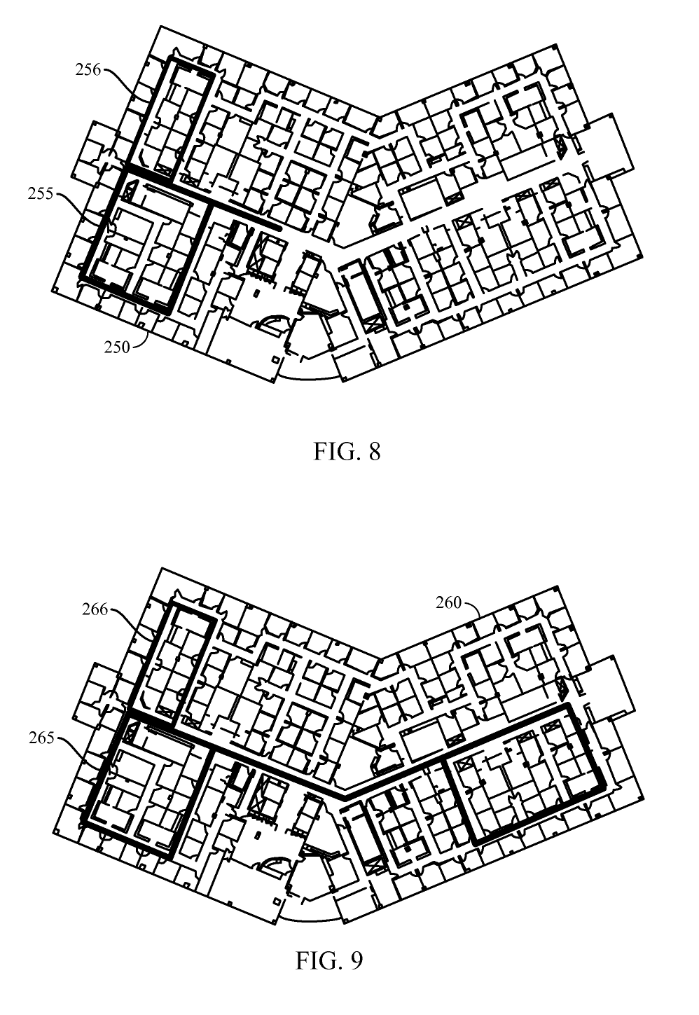

FIG. 6 introduces an example of static data that may be used in generating personalized heatmap 157. In FIG. 6, an office map 202 is depicted, with names associated with different offices. For example, Joan is associated with office 205. Thus, to develop a personalized heatmap for Joan, the location of office 205 may be used as a high feasibility location, even though for general heatmap 150, office 205 would not likely factor as a high feasibility location given a large amount of motion data for different people. The personalized heatmap 157 can be a weighted personalized heatmap. The general heatmap can be a weighted general heatmap. Heatmaps can be viewed as containing specified feasibility descriptions.

FIG. 7 depicts an example of approaches to designate areas for self-sourcing captured device data, or otherwise indicating locations associated with respective transform functions that may be used to adapt a static heatmap with device position information in those areas in generating personalized heatmap 157.

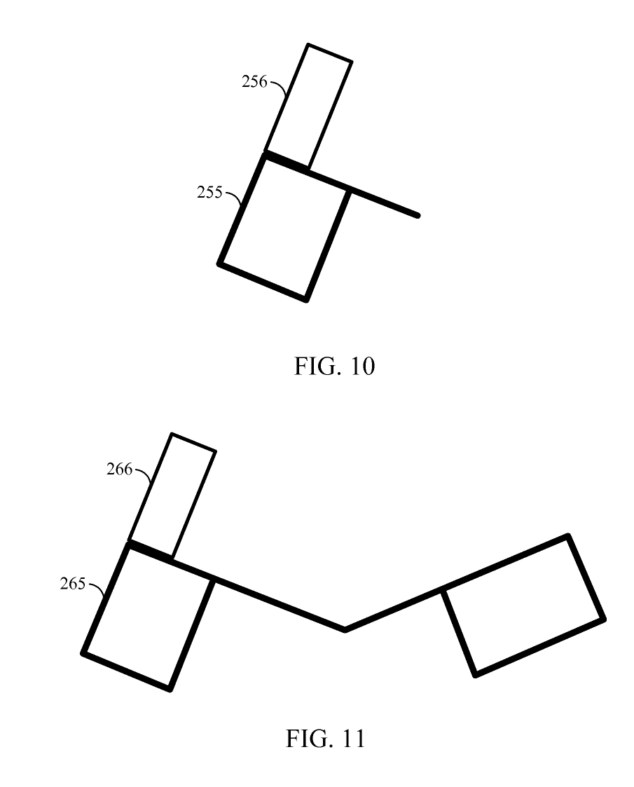

FIGS. 10 and 11 depict medium likelihood 256 and 266 and high likelihood 255 and 265 location information personalized for a user, separate from the underlying layout of the area to which the likelihood information pertains. Such information may be built from self-sourced motion information, for example, such as self-sourced historical position information. Self-sourced historical position information can be used in developing a personal mobility pattern.

In some examples, self-sourcing of movement information from device during regular use is one source of data to be used in generating personalized heatmaps for respective devices. Self-sourced data may be collected and categorized in various ways. For example, a GPS on a mobile device may output position data, associated with time information. Such information can be stored on mobile device, and uploaded to one or more servers. Uploaded data can be anonymized before or after upload. Different use cases may call for different practices of data collection and categorization. These various approaches, structures and methods are examples of means for collecting position information.

One approach to self-sourcing data collection is a mechanism to allow regions to be defined within an area for which a personalized heatmap is to be generated. For example, such regions may be described by one or more polygons overlaying a region on the map. The device may specify criteria or attributes for mobility in that region. For example, an effect of mobility in that region on generating the personalized heatmap may be specified. As another example, points (may be a 3-D coordinate) may be specified within a collection area, where such points may describe position feasibility for the device proximate that point.

For example, a region (e.g., regions 215, 217, 218, 219, 220) may be designed for collection of data, and may be associated with a specified function. For such points and regions, transformation functions may be defined and applied, to modify the input static feasibility heatmap to create a personalized one. Such functions may be specific to a point or region, or may be shared among points, regions, or a combination thereof.

Such region identification also may be used to identify regions in which crowdsourcing or generalized data is to be used in position estimation, rather than personalized data. Also, crowdsourcing data collection may provide a mechanism to identify regions where personal data collection, personalized heatmaps or other personalization may be useful. For example, regions of apparently random motion, or where data collected for a particular person is not expected to be relevant to personal predictions may be allocated to static or shared heatmaps. For example, an airport security line traversed by a particular user on one occasion may not provide a great deal of information, by itself, for subsequent mobility behavior. Rather, the larger pattern of crowds at the security line, which comprises an aggregated statistic would be more predictive of that user particular users experience on a subsequent airport visit. Therefore, in such situations, a generalized heatmap would dominate or be more heavily weighted than a personalized heatmap.

By contrast, areas of high impact self-source opportunity may be identified. For example, where a large number of users may be categorized into sets or other classes so that personalization may be done for different sets of users is an opportunity for self-sourcing. In such areas, personalized heatmap information can be weighted to dominate generalized heatmap information.

Dynamic information also may be used to adapt personalized heatmaps. Calendar information is an example of dynamic information, such as real-time calendar information. For example, a meeting may be scheduled in a device calendar (and which therefore is personal to the user of the device). If the location of the meeting is known, then that location and surrounding locations may be augmented to have higher feasibility for personalized heatmap 157. As a corollary, rooms other than the location of the meeting may have reduced feasibility.

Other examples of dynamic data made available through social network sites or feeds, short message promulgation services, and text messages. Such data may be processed for information relevant to augmenting personalized heatmap 157. For example, a text message indicating “Meet me at the cafeteria” may be used to augment personalized heatmaps of both a sender and a recipient of such message.

The mobile device may dynamically apply the transformation functions to the self-sourced areas to generate an augmented heatmap. Once applied the functional transformations may create a new heatmap which corresponds to the individual users behavior.

Explicit social networks (e.g., companies or services that help establish and maintain social networks and facilitate associated communications) exist, and may be a source of information for customizing feasibility patterns. Such information may include context, and network information. For example, close friends in a social network setting may exhibit similar behaviors when shopping at the mall, for example. Other examples may be if a person has indicated that they follow or otherwise like a particular product, brand, service provider, and so on, such information may be used in conjunction with other information to customize position feasibility data for particular users.

Information about mobility patterns gleaned from some users may be used to augment or modify personalized position heatmaps for other users. Mobility patterns may be shared among network users, allowing more robust patterns to be developed. Such interaction may be facilitated by a third party and may also be accomplished with peer to peer communications. For example, location and time are a common context for users in the same vicinity at the same time, so that a peer-to-peer solution is a practical implementation of the disclosed data exchange.

Additionally, implicit social networks may be inferred from a variety of factors or other available information. For example, an implicit social network may be inferred based on commonality of shopping location or venue (e.g., multiple users going to, who have been, or who have a habit of going to the same store). Such an implicit social network may be considered a set of users who may have at least loosely correlated mobility patterns.

Other examples of implicit networks include office team members. For example, groups or teams in an office setting may be found in similar areas and have similar mobility pattern. For example, team members may share meeting areas, and have proximal home office locations, and so on. Information about work teams may be gathered from profiles, obtained from workplace materials, by recurring meetings, organization charts, and so on.

In this case, if User B is in User A's social network (friends, college, etc.) we may speculatively enhance User A's pattern with some or all of User B's info. These patterns may be combined in multiple ways. For example, User A could build a mobility pattern that adds its own to a weakened version of B's mobility data.

Some implementations may use inferred social networks to customize feasibility patterns. In one example, users may form networks by class. Data may be collected by a server about multiple users. A classification system may be applied using profile information from the phones in order to group or classify the users into sets. Classified users may than form a “loose network.” For example, a User A visits Starbucks often and builds a mobility profile. A new user B enters Starbucks, and may obtain User A's mobility profile and use that profile as is, or modify it, to build a personalized mobility profile. User A and User B may be considered in a loose network, to the extent that User B and User A may have a great portion of a mobility profile in common.

Context awareness may be used to determine when to apply particular or selected feasibility patterns in locational decisions. Although self-sourcing may be a powerful mechanism to give a more personalized experience of a particular user's behavior, self-sourcing may be extended by determining how a user's mobility pattern may be augmented in a particular context. In an example, if a User X is with a User Y then the expected movement pattern of User X should be correlated to that of User Y. For example, in an office situation, when User X and User Y are in close proximity, they tend to go to a particular destination together from a particular starting location. For example, if two users are at the mall together, they tend to go to the same shopping areas. Grouping or proximity calculations may be implemented or aided using short range communication, such as a personal area network wireless communication protocol. Such grouping or proximity calculations also may be coordinated by a server that receives or calculates separate positions to determine proximity.

A personalized mobility pattern may be tagged with context meta-data which may be processed by the mobile device itself or processed by a server to find correlated information. Context may also be collected from various components on the mobile device itself. These include applications that may be running on the device or modules dedicated to inferring device context.

Pattern recognition applied to available information may be used predict mobility patterns and augment location feasibility patterns accordingly.

In many cases, a location based system is used for routing. This is also the case in an indoor location setting. When a user performs a search and routes to a particular location, the probability of the mobility pattern converging to the designated route is high and it would make sense to augment feasibility heatmaps to reflect this aspect. For example, a user may go to a given mall and generate feasibility heatmap data favoring a subset of stores or other activities there. That feasibility heatmap data may be a basis for developing a subsequent feasibility heatmap for a different mall, by extrapolation, such that routes from a user's location to such subset of stores may have attributed higher feasibilities.

Some situations may allow higher confidence in predictions made from the available data. For example, in a routing situation, the likelihood that a user adheres to a computed route or destination for the route is high. However, a user visiting a given store in one mall may be more weakly predictive of a destination of the user during a visit to another mall.

This type of information may either be processed by the mobile devices itself or done statically on a given server which generates personalized feasibility heatmaps for a set of users.

FIG. 12 depicts an example process for gathering self-sourced information, according to the disclosure. At 303, the example stores data defining one or more regions within an area that is (or will be) associated with a general and personalized heatmap, using stored data. These areas can be augmentation regions where data is collected for augmenting general and/or personalized heatmaps. At 305, data is stored that is indicative of a significance of the defined region(s). For example, stored data may identify a region as a self-sourced data collection region; other stored data may associated specific transform functions with particular regions. At 307, a personalized heatmap may be updated with data collected from one or more mobile devices, and subsequently transformed, according to an identified transform function. For example, a region may be identified as a self-source data collection region, and associated with a particular transform function. Such transform function(s) may serve as programming means to effect FIGS. 4 and 5. At 308, augmenting of personalized heatmap data can be based on accessed points of interest data associated within the area to which the general heatmap pertains. Some of these points of interest may be more relevant to a particular user. Regions around such points of interest can be determined higher likelihood locations. Other data and context can be used to affect the personalized heatmap (see above). At 309, for example, regions that are identified as crowd sourced regions also may have data collected; however, the data processing may proceed in an unsegregated manner, such that data from a number of users is collected together and used to form aggregate information.

FIG. 13 depicts an example process for inferring implicit social networks, from which data may be gathered and used in forming personalized heatmaps. At 315, data concerning a group of users is collected. For example, such users may be users who have visited a particular location for which a general heatmap is available. Data concerning such uses is gathered, such data may include shared locational history, shared interests, shopping preferences, shared backgrounds, work, organizational affiliation and so on. At 317 and 319, using such information, the users are assigned or otherwise added, to sets in order to establish implicit or inferred social networks. From those implicit social networks, data pertinent to members of the sets may be gathered, in order to update, create or hybridize personalized heatmaps, as described below.

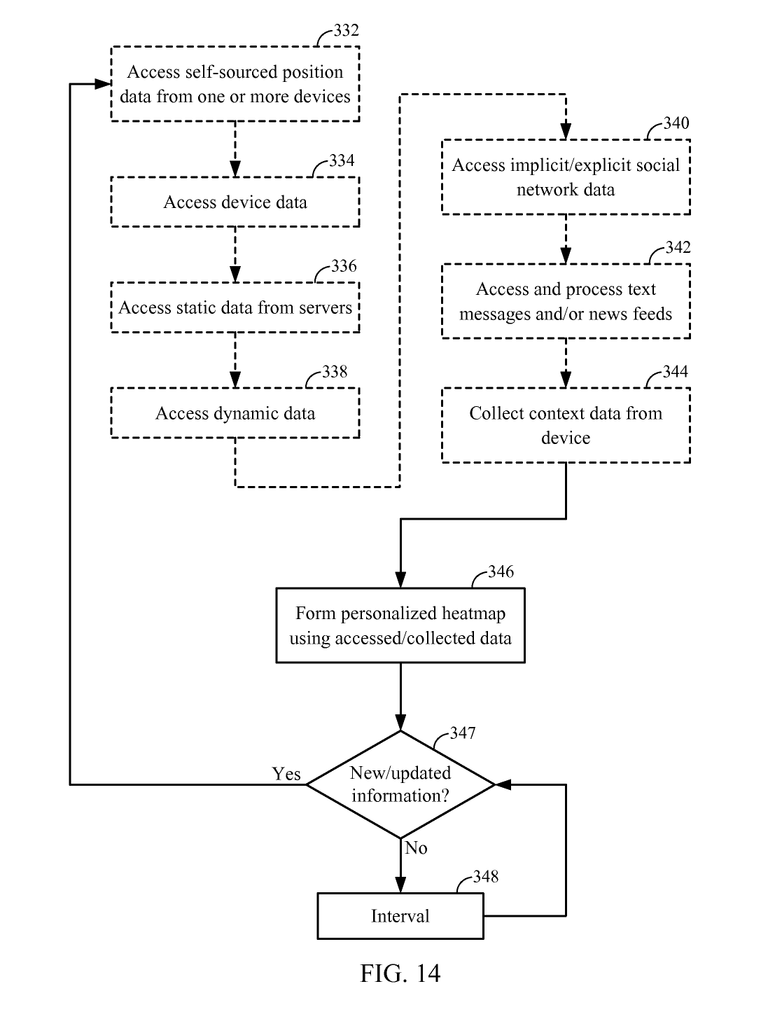

FIG. 14 depicts an example process for creating a personalized heatmap, and which incorporates any one or more of described approaches and sources of data disclosed above. Because these approaches and sources of data were described in detail above, such detail is omitted here to avoid undue repetition. Each approach to produce, obtain or access data that may be used in generating personalized heatmaps is identified by a separate block; however, it would be understood that many personalized heatmaps would use only a selection of such approaches or data sources. At 332, self-sourced position data is accessed from one or more devices. At 334, device data may be accessed (e.g., contacts). At 336, static data from servers may be accessed (e.g., floor maps, company directors, organization charts). As an example, floor maps may include points of interest data such as bathrooms, common areas, cafeterias, office locations, main doors, parking garages, and so on. Such points of interest data may be area specific. A given area may have specified mobility criteria, such as one way paths, temporary construction detours, and so on. At 338, dynamic data may be accessed. At 340, implicit and explicit social network data may be accessed. Such data may be area specific. At 342, messages, such as text messages and news feeds pertaining to the user may be accessed. At 344, context data pertaining to the mobile device may be obtained, such as from the mobile device. At 346, a personalized heatmap is generated using one or more portions of accessed data. At 347, the process may repeat responsive to new or updated information. At 348, an interval or other timer may elapse, causing a check for new or updated information, which may trigger repetition of the process, or a module to process the new or updated information.

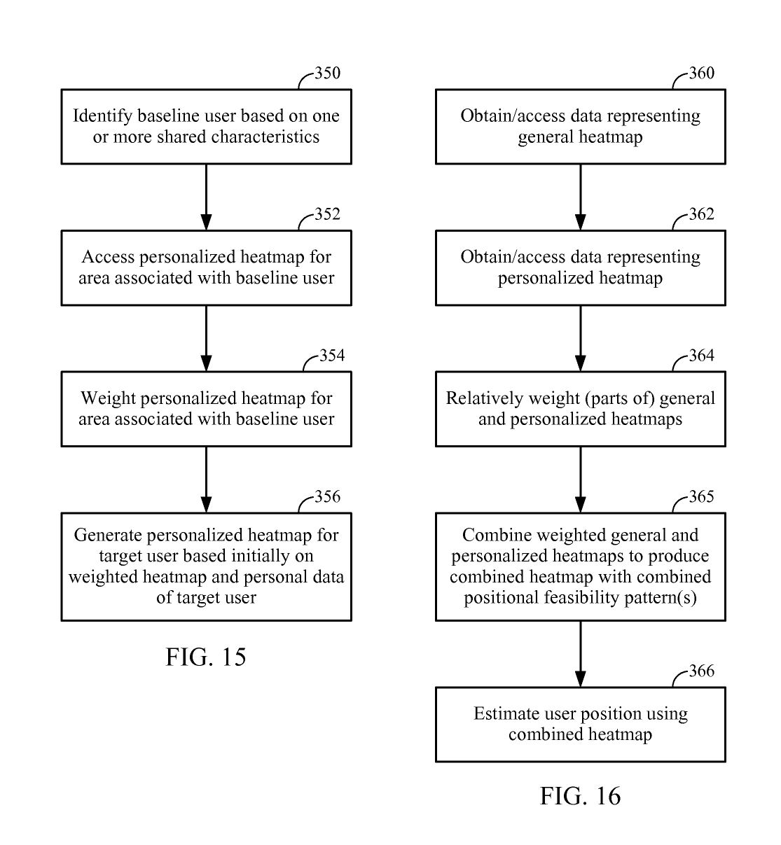

The data accessed as depicted in FIG. 14 also may be used as inputs to different processed depicted and described herein. As such, portions of, or the entirety of, the process depicted in FIG. 14 may be implemented in connection or with other processes. FIG. 15 depicts an example process that may use inputs generated or accessed as depicted in FIG. 14.

FIG. 15 depicts an example process of forming a personalized heatmap for a particular user or device (a “target user”) by initially using another personalized heatmap (e.g., associated with a different device or user). At 350, a baseline user is identified by one or more characteristics shared between the target user for which the heatmap is to be formed and the baseline user. For example, static data from servers (accessed at 336, FIG. 14), may indicate that the baseline user shares a work group or a manager with the target user. At 352, a personalized heatmap for an area associated with the baseline user is accessed. As such, dynamic data accessed at 338 (e.g., calendar information), may be processed to identify meetings associated with that manager or group, and the personalized heatmap for the target user may be made to closely track an established heatmap pattern for the baseline user during, before, or after times related to such meetings. A personalized heatmap generated initially is an initially generated personalized heatmap.

More concretely, at 354, the personalized heatmap, or a selected portion thereof may be weighted, and combined (see FIG. 5) with personalized heatmap data existing for the target user (if any). An amount of weight or significance to give to the heatmap data of the baseline user may depend on an expected correlation between the baseline user's and the target user's movements during the relevant time or region within the area, or within the area. For example, for a group meeting of a team on which both the baseline user and the target user are members, correlation may be expected to be quite high. However, such correlation may be considerably less with respect to other parts of a heatmap for a baseline user. Thus, such weighting may be variable for different parts of the baseline user's heatmap. For example, locational data that is expected to correlate highly to the one or more shared characteristics is more strongly weighted than data that is expected to correlate more weakly. For example, self-sourced position data accessed at 332 may indicate a propensity for the user to prefer a particular type or brand of restaurant for lunch, when that user worked at a different company. Now, at a new company, such self-sourced data may still be predictive of lunch preferences, and may be more highly weighted than lunchtime locational heatmap data for the baseline user. At 356, a personalized heatmap is generated for the target user, according to the weightings determined at 354.

FIG. 16 depicts an example process of combining a general heatmap for a particular area with a personalized heatmap for that area. At 360, data representing a general heatmap is obtained. At 362, data representing a personalized heatmap is obtained. A server or mobile device may be used for gathering and using such information to enhance and personalize position heatmaps. At 364, a general heatmap and a personalized heatmap, or parts of such heatmaps, are weighted. In an example, portions of each heatmap can be weighted differently. Based on other available information, portions of each heatmap can be assigned a respective weighting that reflects an estimated predictiveness of the information to the current position of the user. For example, a calendar entry indicating a particular conference room for a meeting can be considered highly predictive, and therefore, the portion of the heatmap covering that conference room can be weighted higher than if that calendar information were unavailable. At 365, an allocation can be assigned to each of the general and personalized heatmap (such as 40% general and 60% personal), in determining positional likelihoods for the combined heatmap. At 365, the weighted heatmaps (i.e., weighted general heatmap and weighted personalized heatmap) are combined to produce combined heatmap with a combined positional feasibility pattern. From the combined heatmap, at 366, a user position is estimated. In an example, the user position also a position of a personal mobile device of that user. However, in other examples, the user may have multiple personal mobile devices, and the user may not always have all such mobile devices with them. In another example, a mobile device may be shared among a plurality of users, and so a position of a current user (e.g., a currently logged-in user) of that mobile device would have an estimated position that is congruent with an estimated position of that mobile device.

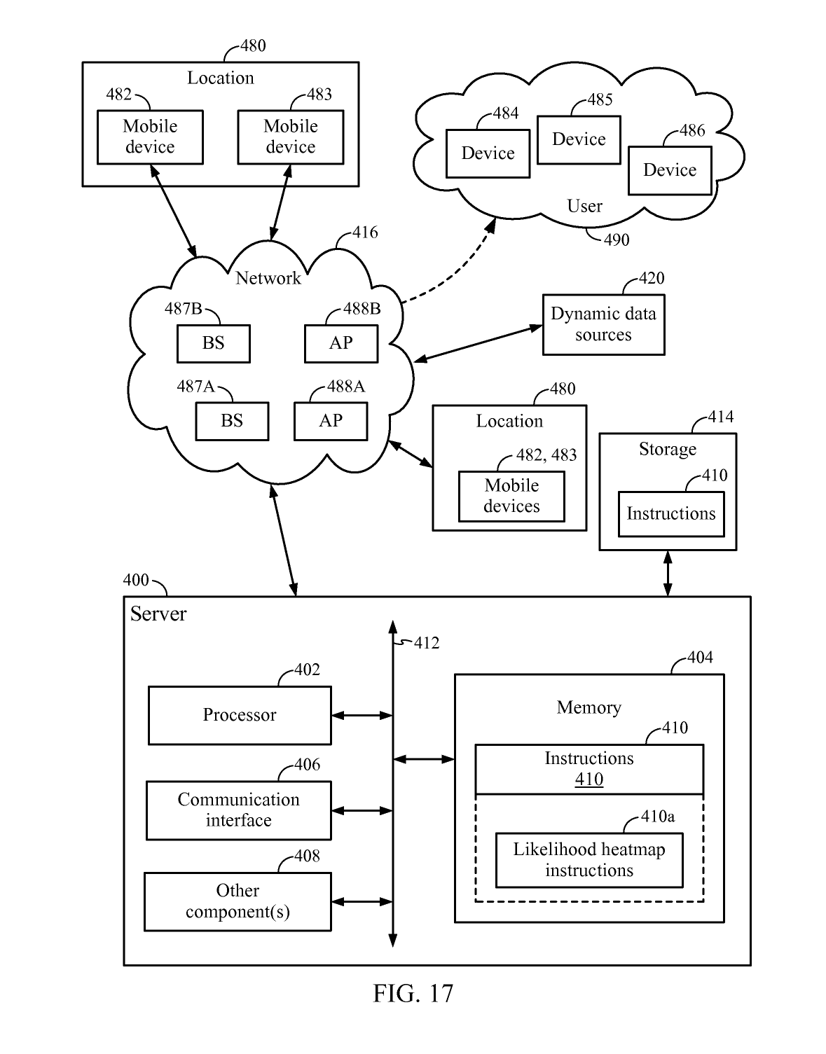

FIG. 17 is a schematic diagram illustrating an example server 400, according to an implementation, which may implement one or more aspects of indoor likelihood heatmaps according to an implementation. As illustrated, server 400 may include at least one processor 402, memory 404, at least one communication interface 406, and one or more other component(s) 408. The figure also illustrates at least one storage medium 414 and one or more networks 416. A server 400 may have access to storage medium 414 or networks 416. Memory 404 or storage medium 414 may include instructions 410.

For certain example implementations, server 400 may include or comprise at least one electronic device, such as a device with processing capabilities. Server 400 may comprise, for example, any electronic device having at least one processor or memory. Examples of a server 400 may include a desktop computer, one or more server blades, at least one server machine, a server farm, at least one telecommunications node, an intelligent router or switch, an access point, or any combination thereof.

One or more processors 402 may comprise one or more separate or integrated processors. Processor 402 may be programmed with instructions, such as instructions 410, to become a special purpose processor that implements at least a portion of any procedure(s) that are described herein. Memory 404 may store, contain, or otherwise provide access to at least a portion of instructions 410 that may be executable by processor 402. Examples for instructions 410 may include: a program, or an application, etc. or portion thereof; operational data structures; processor-executable instructions; computer-implemented instructions; code or coding; or any combination thereof; etc. Execution of instructions 410 by one or more processors 402 may transform server 400 into a special purpose computing device, apparatus, platform, or any combination thereof.

Instructions 410 may include likelihood heatmap instructions 410a. In an example implementation, a server 400 may execute likelihood heatmap instructions 410a to generate an indoor likelihood heatmap. For example, one or more servers may generate a likelihood heatmap based, at least in part, on a count of shortest paths between pairs of points that traverse a particular point of connectivity graph as constrained by a sparse connectivity graph.

At least one communication interface 406 may provide one or more hardware or software interfaces between server 400 and other devices or human operators. Hence, communication interface 406 may comprise a screen, a speaker, a microphone, a camera, a keyboard or keys, or other human-device input or output features. Additionally or alternatively, a communication interface 406 may comprise a transceiver (e.g., a transmitter or a receiver), a radio, an antenna, a network interface (e.g., a wired hardware interface connector, such as a network interface card; or a wireless interface connector, such as a Bluetooth® or near field communication (NFC) unit; etc.), a local hardware interface (e.g., a universal serial bus (USB) connector, etc.), or any combination thereof, to communicate wireless and/or wired signals (e.g., over wireless or wired communication links) via one or more networks 416. Communications using at least one communication interface 406 may enable transmitting, receiving, or initiating of transmissions, etc., just to name a few examples.

One or more networks 416 may comprise at least one wireless or wired network. Examples of networks 416 may include a local area network (LAN), a wireless LAN (WLAN), a wide area network (WAN), a wireless WAN (WWAN), a cellular network, a telecommunications network, the internet, an ad hoc network, an infrastructure network, or any combination thereof. Network 416 may include one or more base stations 487A-487B and/or one or more access points 488A-488B, for example. Such infrastructure also may be sources of signals that can be used in position estimation.

A storage medium 414 may store, for example, at least a portion of instructions 410. A storage medium 414 may be external (as shown) to server 400. If external, storage medium 414 may be local or remote from server 400. An external implementation of a storage medium 414 may comprise a separate memory device or may comprise part of another electronic device. Although not so explicitly illustrated, storage medium 414 may also or alternatively be located within, or be internal to, server 400. Examples of storage medium 414 may include a hard drive, a disk, a disc, a storage array, volatile memory, nonvolatile memory, a USB drive, a memory card, a computer-readable medium, or any combination thereof.

Server 400 may include at least one interconnect 412 that comprises one or more buses, channels, switching fabrics, storage area networks, or combinations thereof, to enable signal communication between or among components of server 400. Other component(s) 408 may comprise one or more other auxiliary processing, storage, or communication components; power sources; apparatuses providing other feature(s); or any combination thereof. Although not explicitly illustrated in FIG. 17, one or more components of server 400 may be coupled to interconnect 412 via a discrete or integrated interface. By way of example only, an interface may couple processor 402 or communication interface 406 to interconnect 412.

In example implementations, a device, such as server 400, may comprise at least one memory 404 and one or more processors 402. At least one memory 404 may store instructions 410. One or more processors 402 may be configured to execute instructions 410, e.g., to perform one or more procedures, processes, operations, or any combination thereof. In example implementations, an article (e.g., an article of manufacture) may comprise at least one storage medium 414. At least one storage medium 414 may have stored thereon instructions 410 that are executable by one or more processors 402, e.g., to perform one or more procedures, processes, operations, or any combination thereof.

FIG. 17 also depicts a location 480, at which a plurality of mobile devices 482, 483 may be concurrently located. The concurrent shared locality of mobile devices 482 and 483 provide for an opportunity to determine whether elements of respective personalized heatmaps for such devices may be shared between the devices, or whether information pertinent to a joint probability calculation may be inferred.

Additionally, FIG. 17 depicts that a plurality of devices 484-486 may be associated with a user 490. Devices 484-486 each can be used separately or together by user 490, and can be a source of self-sourced position information that is used in forming a personalized heatmap. In some situations, one or more of devices 484-486 also can be used by other users. For example, a mobile device may have multiple user accounts, and at different times, different users who have an account on that device can use that device. When a given user is using a given device, then positional information gathered from that device would be used in determining or updating a personalized heatmap for each such user.

FIG. 17 also depicts dynamic data sources 420 containing dynamic data. Dynamic data sources 420 may comprise feeds generated from social network sites, calendar updates from an Exchange® server, Really Simple Syndication (RSS) feeds, short messaging service (SMS) feeds, and so on.

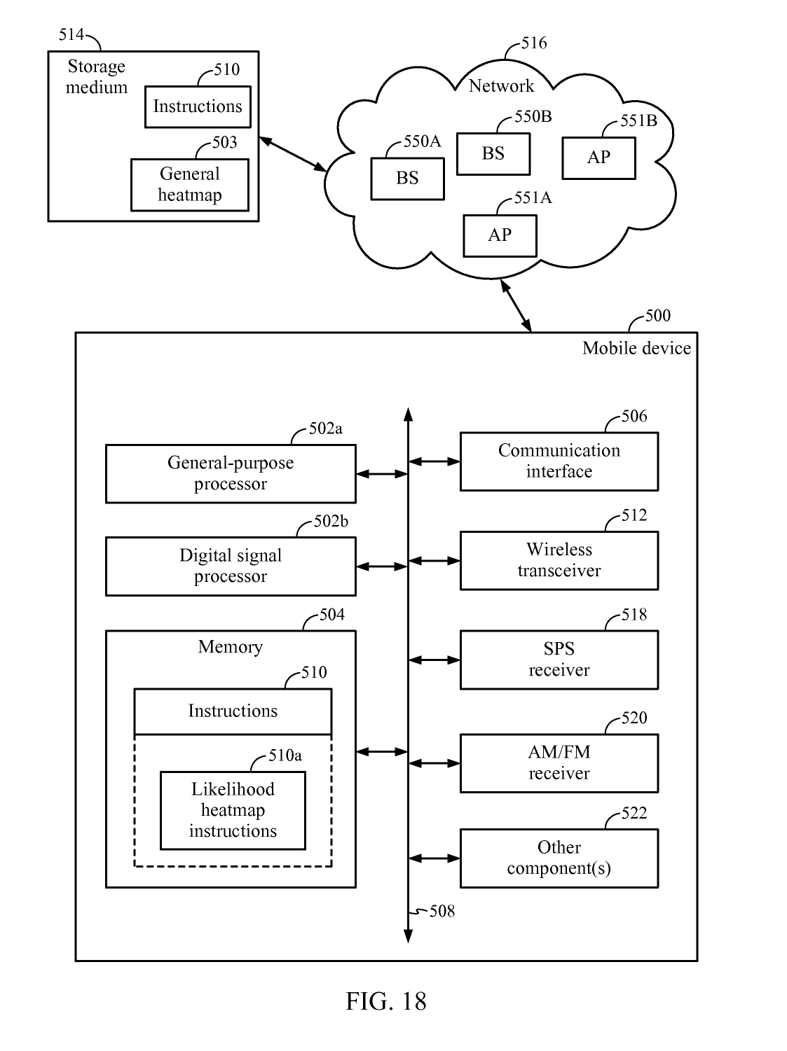

FIG. 18 is a schematic diagram illustrating an example mobile device 500, according to an implementation, that may implement one or more aspects relating to indoor likelihood heatmaps including, for example, generation of a likelihood heatmap or application of a likelihood heatmap according to a particular implementation. As illustrated, mobile device 500 may include at least one processor 502 (e.g., a general-purpose processor 502a or a digital signal processor 502b), at least one memory 504, at least one communication interface 506, at least one interconnect 508, at least one wireless transceiver 512, at least one SPS receiver 518, at least one AM/FM receiver 520, or one or more other component(s) 522, or any combination thereof. SPS receiver 518 is a means for collecting position data. FIG. 18 also illustrates at least one storage medium 514 or one or more networks 516. A mobile device 500 may have access to storage medium 514 or networks 516. Memory 504 or storage medium 514 may include instructions 510.

For certain example implementations, a mobile device 102 (e.g., of FIG. 1) may comprise a mobile device 500. Mobile device 500 may include or comprise at least one electronic device, such as a device with processing capabilities. Mobile device 500 may comprise, for example, any electronic device having at least one processor or memory. Examples of a mobile device 500 may include a notebook or laptop computer, a personal digital assistant (PDA), a netbook, a slate or tablet computer, a portable entertainment device, a mobile phone, a smart phone, a mobile terminal (MT), a mobile station (MS), a user equipment (UE), a personal navigation device (PND), or any combination thereof.

One or more processors 502 may comprise one or more separate or integrated processors. As illustrated, one or more processors 502 may comprise a general-purpose processor 502a, a digital signal processor 502b, or any combination thereof. General-purpose processor 502a may be programmed with instructions, such as instructions 510, to become a special purpose processor that implements at least a portion of any process(es), method(s), or procedure(s), etc. that are described herein. A digital signal processor (DSP) 502b may comprise a processor having an architecture that is at least partially enhanced to process digital signals. Digital signal processor 502b may be programmed with instructions, such as instructions 510, to become a special purpose digital signal processor that implements at least a portion of any process(es), method(s), or procedure(s), etc. that are described herein. General-purpose processor 502a or digital signal processor 502b may operate individually or jointly to implement any e.g. procedure(s) that are described herein.

Memory 504 may store, contain, or otherwise provide access to at least a portion of instructions 510 that may be executable by a processor 502. Examples for instructions 510 may include: a program, or an application, etc. or portion thereof; operational data structures; processor-executable instructions; computer-implemented instructions; code or coding; or any combination thereof. Execution of instructions 510 by one or more processors 502 may transform mobile device 500 into a special purpose computing device, apparatus, platform, or any combination thereof.

Instructions 510 may include, by way of example, likelihood heatmap instructions 510a. In certain example implementations, likelihood heatmap instructions 510a may correspond to, for example, instructions that are capable of realizing at least a portion of one or more implementations of exemplary processes, such as those of FIGS. 12-16. In an example implementation, a mobile device may execute likelihood heatmap instructions 510a to use an indoor likelihood heatmap in conjunction with a navigational application.

At least one communication interface 506 may provide one or more hardware or software interfaces between mobile device 500 and other devices or human operators. Hence, communication interface 506 may comprise a screen, a speaker, a microphone, a camera, a keyboard or keys, or other human-device input or output features. Additionally or alternatively, a communication interface 506 may comprise a transceiver (e.g., a transmitter or a receiver), a radio, an antenna, a network interface (e.g., a wired hardware interface connector, such as a network interface card; or a wireless interface connector, such as a Bluetooth® or near field communication (NFC) unit; etc.), a local hardware interface (e.g., a universal serial bus (USB) connector, etc.), or any combination thereof, to communicate wireless and/or wired signals (e.g., over wireless or wired communication links) via one or more networks 516. Communications using at least one communication interface 506 may enable transmitting, receiving, or initiating of transmissions, etc., just to name a few examples.

One or more networks 516 may comprise at least one wireless or wired network. Examples of networks 516 may include a local area network (LAN), a wireless LAN (WLAN), a wide area network (WAN), a wireless WAN (WWAN), a cellular network, a telecommunications network, the internet, an ad hoc network, an infrastructure network, or any combination thereof. Network 516 may be implemented using infrastructure components such as base stations 550A-550B, and access points 551A-551B. Such infrastructure components, or selections thereof, may serve as a communication path to network accessible storage, and may also serve as signal sources for position estimation.

A storage medium 514 may comprise memory to store, for example, at least a portion of instructions 510. A storage medium 514 may be external (as shown) to mobile device 500. If external, storage medium 514 may be local or remote from mobile device 500. An external implementation of a storage medium 514 may comprise a separate memory device or may comprise part of another electronic device. Although not so explicitly illustrated, storage medium 514 may also or alternatively be located within, or be internal to, mobile device 500. Examples of storage medium 514 may include a hard drive, a disk, a disc, a storage array, a storage network, volatile memory, nonvolatile memory, a USB drive, a memory card, a computer-readable medium, or any combination thereof.

Additionally or alternatively to communication interface 506, mobile device 500 may include one or more transmitters, receivers, transceivers, or any combination thereof. By way of example only, a mobile device may include at least one wireless transceiver 512, at least one SPS receiver 518, at least one AM/FM receiver 520, or any combination thereof. A wireless transceiver 512 may transmit or receive wireless signals in accordance with, e.g., at least one selected protocol. Example protocols may include a cellular or WWAN protocol, a Wi-Fi protocol, a Bluetooth® protocol, or any combination thereof. Wireless transceiver 512 may communicate, for example, with network 516 via wireless signals. An SPS receiver 518 may at least receive SPS signals from one or more satellites, pseudolites, positioning beacons, or any combination thereof. An AM/FM receiver 520 may at least receive amplitude modulated (AM) or frequency modulated (FM) signals. Although not explicitly shown in FIG. 18, wireless transceiver 512, SPS receiver 518, AM/FM receiver 520, or any combination thereof, may be coupled to one or more individual antennas or shared antennas.

Mobile device 500 may include at least one interconnect 508 that comprises one or more buses, channels, switching fabrics, or combinations thereof, to enable signal communication between or among components of mobile device 500. Other component(s) 522 may comprise one or more other sensors, power sources, apparatuses providing other feature(s), or any combination thereof. In an example implementation, sensors may include a thermometer, a barometer, an accelerometer, a compass, a gyroscope, a pedometer, or any combination thereof. Although not explicitly illustrated in FIG. 5, one or more components of mobile device 500 may be coupled to interconnect 508 via a discrete or integrated interface. By way of example only, one or more interfaces may couple wireless transceiver 512 or general-purpose processor 502a to interconnect 508.

In example implementations, a device, such as mobile device 500, may comprise at least one memory 504 and one or more processors 502. At least one memory 504 may store instructions 510. One or more processors 502 may be configured to execute instructions 510, e.g., to perform one or more procedures, processes, operations, or any combination thereof. In example implementations, an article (e.g., an article of manufacture) may comprise at least one storage medium 514. At least one storage medium 514 may have stored thereon instructions 510 that are executable by one or more processors 502, e.g., to perform one or more procedures, processes, operations, or any combination thereof.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that may be accessed by a computer. By way of example such computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method for position estimation, the method comprising:
accessing from a non-transitory medium, a general heatmap representing a generic position feasibility pattern for mobile devices within an area to which the general heatmap pertains;
accessing a personalized heatmap from the non-transitory medium, a personalized heatmap representing a position feasibility pattern for a user, within the area to which the general heatmap pertains;
combining data from the general heatmap and the personalized heatmap to form a combined heatmap; and
estimating a current position of the user using the combined heatmap.

2. The method of claim 1, wherein the combining comprises relatively weighting the general heatmap and the personalized heatmap to form a combined positional feasibility pattern.

3. The method of claim 1, further comprising generating the personalized heatmap based on position information gathered from one or more mobile devices associated with the user within the area to which the general heatmap pertains.

4. The method of claim 3, further comprising regenerating the personalized heatmap responsive to availability of any of new, additional, and updated information.

5. The method of claim 1, wherein generating of the personalized heatmap comprises:
obtaining position history information associated with the user;
weighting the position history information; and
combining the weighted position history information according to other location feasibility information to generate the personalized heatmap.

6. The method of claim 1, wherein the non-transitory medium storing the personalized heatmap is local to a mobile device associated with the user, and the combining is performed by the mobile device.

7. The method of claim 1, wherein the generating of the personalized heatmap for the area comprises predicting one or more high feasibility regions within the area, based on a different personalized heatmap for a different area and one or more characteristics shared between the area and the different area.

8. The method of claim 1, wherein the generating of the personalized heatmap for the area comprises predicting one or more high feasibility regions within the area, based on a contextual element shared between a mobile device associated with the user and a different mobile device determined to be in proximity to the mobile device associated with the user.

9. The method of claim 1, wherein the generating of the personalized heatmap for the area comprises predicting locational feasibility for one or more regions within the area, based on a contextual element shared between the user and a different mobile device user determined to be in proximity to the user.

10. The method of claim 1, wherein the generating of the personalized heatmap comprises initializing the personalized heatmap with information from a different personalized heatmap specific to a different user, a different mobile device selected based on a characteristic shared between a mobile device and the different mobile device or respective users of the mobile device and the different mobile device.

11. The method of claim 10, further comprising identifying of the characteristics using social network information from the users of the mobile device and the different mobile device.

12. The method of claim 1, wherein the general heatmap is based on crowd sourcing.

13. The method of claim 1, wherein a plurality of users are capable of using a mobile device, and the method further comprises determining the personalized heatmap, from a plurality of personalized heatmaps associated respectively with the plurality of users according to which of the plurality of users is currently using the mobile device.

14. The method of claim 1, further comprising collecting position data of a mobile device and periodically augmenting the personalized heatmap in one or more augmentation regions.

15. The method of claim 1, wherein the generating of the personalized heatmap further comprises determining a set of personalized augmentation regions and a set of general regions within the personalized heatmap.

16. The method of claim 1, wherein the personalized heatmap comprises location feasibility information resulting from processing one or more of position history of a mobile device, a calendar and a contact list on the mobile device.

17. The method of claim 1, wherein the personalized heatmap comprises personal information obtained from a network-accessible repository of information about a specific user.

18. The method of claim 17, wherein the network-accessible repository of information comprises information available from social networking services used by the specific user.

19. The method of claim 17, wherein the network-accessible repository of information comprises information pertaining to an organization to which the user is associated.

20. The method of claim 1, wherein the generating of the personalized heatmap comprises using information obtained from a message between the user of a mobile device and a third party.

21. The method of claim 1, wherein the generating of the personalized heatmap comprises using information obtained from peer to peer communications between a mobile device and a different mobile device, in which the different mobile device is determined according to commonality of location.

22. The method of claim 1, wherein the personalized heatmap comprises information obtained from a different mobile device, and the method further comprises selecting the different mobile device from a plurality of mobile devices according to a social network inferred by one or more characteristics shared between the respective users of a mobile device and the different mobile device.

23. The method of claim 22, further comprising adding to the social network and refining the personalized heatmap using the information derived from personalized heatmaps associated with additions to the social network.

24. The method of claim 1, wherein the combining data from the general heatmap with data from the personalized heatmap to generate the combined heatmap comprises:
weighting the general heatmap to form a weighted general heatmap;
weighting the personalized heatmap to form a weighted personalized heatmap; and
summing the weighted general heatmap and the weighted personalized heatmap to generate the combined heatmap.

25. The method of claim 24, wherein the weighting of the personalized heatmap comprises weighting portions of location information from the personalized heatmap according to time of day and day of week information.

26. A mobile device for position estimation, the mobile device comprising:
a receiver operable for receiving data representative of a general heatmap, the general heatmap representing a generic position feasibility pattern for mobile devices within an area to which the general heatmap pertains; and
a processor configured to generate a personalized heatmap specific to the mobile device independently from the general heatmap, to combine the general heatmap and a personalized heatmap to produce a combined heatmap, and to determine an estimate of a position of the mobile device from the combined heatmap.

27. The mobile device of claim 26, wherein the processor is configured to regenerate the personalized heatmap responsive to availability of new or additional information pertaining to locational feasibility of the mobile device.

28. A mobile device for position estimation, the mobile device comprising:
means for receiving a general heatmap, the general heatmap representing a generic position feasibility pattern for mobile devices within an area to which the general heatmap pertains;
means for generating a personalized heatmap specific to the mobile device, a personalized heatmap generated independently from the general heatmap;
means for combining the personalized heatmap and the general heatmap to produce a combined heatmap; and
means for determining an estimate of a position of the mobile device from the combined heatmap.

29. The mobile device of claim 28, wherein the means for combining comprises a means for weighting the general heatmap to form a weighted general heatmap, for weighting the personalized heatmap to form a weighted personalized heatmap, and for summing the weighted general heatmap and the weighted personalized heatmap to generate the combined heatmap.

30. The mobile device of claim 28, further comprising:
means to collect position data; and
means to send the position data to a server for forming the general heatmap.

31. The mobile device of claim 28, wherein the means for generating comprises:
means for predicting locational feasibility for regions of the area, to form predicted locational feasibilities;
means for weighting the predicted locational feasibilities to form weighted predicted locational feasibilities; and
means for combining the weighted predicted locational feasibilities with other location feasibility information to generate the personalized heatmap.

32. A device comprising a processor and a non-transitory memory wherein the non-transitory memory includes instructions to:
determine a general heatmap for an area in which augmented location services are to be provided, the general heatmap representing a generic position feasibility pattern for mobile devices within the area;
generate a personalized heatmap of an area specific to a mobile device, the personalized heatmap generated independently from the general heatmap; and
provide the personalized heatmap for use in determining an estimate of a position of the mobile device using data from both the general heatmap and on the personalized heatmap.

33. The device of claim 32, wherein the software instructions further comprise software instructions to partition the area into:
regions in which crowd sourced mobility pattern information is collected, and in which the general heatmap dominates; and
regions in which personal mobility pattern data is separately used to generate the personalized heatmap.

34. The device of claim 33, wherein the software instructions further comprise software instructions to:
identify regions of apparently random motion to form random motion regions; and
marking the random motion regions as regions in which the general heatmap dominates.

35. The device of claim 33, wherein the software instructions further comprise software instructions to:
identify regions of apparently random motion to form random motion regions; and
identify those regions as regions in which the general heatmap dominates.

36. The device of claim 32, wherein the software instructions further comprise software instructions to initially generate the personalized heatmap based on point of interest information.

37. The device of claim 33, wherein the software instructions further comprise software instructions to use self-sourced historical position information from the mobile device.

38. The device of claim 37, wherein the software instructions further comprise software instructions to partition the area into one or more of regions and locations in which the personalized heatmap has associated one or more of specified mobility criteria and a specified feasibility description.

39. The device of claim 38, wherein the software instructions further comprise software instructions to apply respective transform functions to the one or more of regions and locations to produce the personalized heatmap.

40. The device of claim 39, wherein one or more of the transform functions are shared among two or more of the regions or locations to produce the personalized heatmap.

41. The device of claim 33, wherein the software instructions further comprise software instructions to use one or more of real time calendar information and social network information feeds associated with a user of the mobile device.

42. A non-transitory computer-readable storage medium including program code stored thereon, comprising program code to:
receive a general heatmap, the general heatmap representing a generic position feasibility pattern for mobile devices within an area to which the general heatmap pertains;
generate a personalized heatmap, wherein the personalized heatmap is specific to a mobile device, and the personalized heatmap generated independently from the general heatmap; and
determine an estimate of a position of the mobile device using data from both the general heatmap and the personalized heatmap.

43. The non-transitory computer-readable storage medium of claim 42, wherein the program code further comprises program code to weight data from each of the personalized heatmap and the general heatmap according to one or more of dynamic and static data.

44. The non-transitory computer-readable storage medium of claim 42, wherein the program code further comprises program code to use a contextual element shared between the mobile device and a different mobile device determined to be in proximity to the mobile device in combining data from both the general heatmap and the personalized heatmap.

45. The non-transitory computer-readable storage medium of claim 42, wherein the program code further comprises program code to identify one or more shared characteristics using social network information from a user of the mobile device and a different user of a different mobile device.

46. The non-transitory computer-readable storage medium of claim 42, wherein the program code further comprises program code to:
access points of interest data associated with the area to which the general heatmap pertains; and
identify one or more points of interest specific to a user of the mobile device and use the one or more points of interest specific to the user in producing the personalized heatmap.

47. The non-transitory computer-readable storage medium of claim 42, wherein the program code further comprises program code to obtain and use one or more position history of the mobile device, a calendar and a contact list on the mobile device, for forming the personalized heatmap.
